(19) United States
(12) Patent Application Publication
(10) Pub. No.: US 2026/0029358 A1
(43) Pub. Date: Jan. 29, 2026

(54) INSPECTION METHOD AND CHARGED PARTICLE BEAM APPARATUS

(71) Applicant: Hitachi High-Tech Corporation, Minato-ku, Tokyo (JP)

(72) Inventors: Minami UCHIHO, Tokyo (JP); Satoshi TAKADA, Tokyo (JP); Makoto SAKAKIBARA, Tokyo (JP); Shota MITSUGI, Tokyo (JP); Yasuhiro SHIRASAKI, Tokyo (JP); Natsuki TSUNO, Tokyo (JP)

(21) Appl. No.: 18/996,537

(22) PCT Filed: Sep. 27, 2022
(86) PCT No.: PCT/JP2022/035887

§ 371 Date: Jan. 17, 2025

(51) Int. Cl. G01N 23/2251

(52) U.S. Cl. CPC G01N 23/2251; G01N 2223/401; G01N 2223/6116

(57) ABSTRACT

An inspection method for inspecting an electrical characteristic of a pattern 102 made of a conductor or a semiconductor in a dielectric region 101 on a sample, the inspection method including: scanning the sample with a charged particle beam to acquire a secondary electron image; calculating a feature based on a luminance value of a third region 113 extending from a boundary between a first region 111 and a second region 112 toward the first region and having a higher luminance than the second region, the first region corresponding to the dielectric region and the second region corresponding to the pattern in the secondary electron image; and the electrical inspecting characteristic of the pattern based on the feature.

### TECHNICAL FIELD

The present invention relates to a charged particle beam apparatus that emits a charged particle beam to a sample, in particular, relates to an inspection method and a charged particle beam apparatus for inspecting electrical and material characteristics of a sample.

### BACKGROUND ART

In a charged particle beam apparatus, for example, a scanning electron microscope (hereinafter abbreviated as SEM), a fine pattern on the order of nanometers can be identified using a focused electron beam. One of SEM observation methods is a voltage contrast method. A voltage contrast is a contrast that reflects a difference in a surface voltage of a sample and reflects conductivity of the sample. A technique for inspecting an electrical characteristic defect of a semiconductor device using this voltage contrast method has been put into practical use. In the inspection of the electrical characteristic defect, a defective portion is specified using a difference in luminance of a pattern in an SEM image. Here, the luminance represents a degree of brightness in a signal of an image or a pixel acquired by the charged particle beam apparatus, and may be referred to as brightness. For example, since a potential is low in a pattern having high conductivity, the luminance is high, and since the potential is high in a pattern having low conductivity, the luminance is low. Thus, a defective part having different conductivity can be detected based on a difference in luminance of an image. As a technique for improving inspection sensitivity of the electrical characteristic defect by the voltage contrast method, PTL 1 discloses a method of setting a region for analyzing luminance of a sample including a plurality of patterns to improve detection sensitivity of an electrical characteristic defect.

### CITATION LIST

### Patent Literature

PTL 1: JP2016-70912A

### SUMMARY OF INVENTION

### Technical Problem

In order to improve the detection sensitivity of the electrical characteristic defect of the sample, it is important to increase a change in the luminance of the image in response to a change in a potential of a region or a pattern to be inspected. The luminance of the SEM image depends on an amount of secondary electrons emitted from the sample, and the amount of secondary electrons emitted depends on a material. In a semiconductor electrical characteristic inspection, a material of a pattern subjected to a conductivity evaluation is often a metal or a semiconductor, and such a material generally has a small amount of secondary electrons emitted. Therefore, luminance of the pattern of the metal or a semiconductor is low, and accordingly, a change in the luminance in response to a potential change is also small, and thus it is difficult to detect an electrical characteristic defect with high sensitivity.

The invention has been made to solve such a problem, and an object thereof is to provide a technique for inspecting an electrical characteristic and a material characteristic of a pattern made of a metal or a semiconductor with high sensitivity.

### Solution to Problem

An inspection method according to an embodiment of the invention is an inspection method for inspecting an electrical characteristic of a pattern made of a conductor or a semiconductor in a dielectric region on a sample, the inspection method including: scanning the sample with a charged particle beam to acquire a secondary electron image; calculating a feature based on a luminance value of a third region extending from a boundary between a first region and a second region toward the first region and having a higher luminance than the second region, the first region corresponding to the dielectric region and the second region corresponding to the pattern in the secondary electron image; and inspecting the electrical characteristic of the pattern based on the feature.

### Advantageous Effects of Invention

An electrical characteristic of a pattern can be inspected with high sensitivity. Other problems and novel features will become apparent from description of the present description and the accompanying drawings.

### BRIEF DESCRIPTION OF DRAWINGS

FIG. 1 is an example of patterns of an observed sample.

FIG. 2 shows SEM images (schematic views) of the patterns shown in FIG. 1.

FIG. 3 shows a mechanism by which a third region is generated.

FIG. 4 is a flowchart showing an example of an inspection method.

FIG. 5A is an example of an SE image (schematic view).

FIG. 5B is an example of a BSE image (schematic view).

FIG. 5C is a luminance profile of the BSE image.

FIG. 5D shows a first region and a second region extracted from the BSE image.

FIG. 6A is an example of extraction of the third region.

FIG. 6B is an example in which the SE image and the third region are displayed in a superimposed manner.

FIG. 7A is an apparatus configuration example of a charged particle beam apparatus in a first embodiment.

FIG. 7B is a hardware structure example of an information processing device.

FIG. 8 is an example of a GUI.

FIG. 9A is an example of an inspection result display method.

FIG. 9B is an example of the inspection result display method.

FIG. 10 is a flowchart showing an example of a method for determining an electron beam condition.

FIG. 11A shows a method for determining the electron beam condition by changing a focusing condition.

FIG. 11B shows a method for determining the electron beam condition by changing the focusing condition.

FIG. 12A shows a method for determining the electron beam condition by changing the focusing condition.

FIG. 12B shows a method for determining the electron beam condition by changing the focusing condition.

FIG. 13 is an apparatus configuration example of a charged particle beam apparatus in a third embodiment.

FIG. 14A is an example of SE images (schematic views) acquired under different electron beam intermittent conditions.

FIG. 14B shows a method for extracting a third region segmentation from the SE images (schematic views) acquired under different electron beam intermittent conditions.

FIG. 14C is an example of an inspection result display method.

FIG. 15 is an apparatus configuration example of a charged particle beam apparatus in a fourth embodiment.

FIG. 16A is an example of SE images (schematic views) acquired under different light emission conditions.

FIG. 16B shows a method for extracting a third region segmentation from the SE images (schematic views) acquired under different light emission conditions.

FIG. 16C is an example of an inspection result display method.

### DESCRIPTION OF EMBODIMENTS

A semiconductor device includes a dielectric region electrically insulated from a pattern made of a metal or a semiconductor that is conductive. Since a boundary of the dielectric region in contact with the pattern made of the metal or the semiconductor has the same potential as a potential of the pattern, a potential gradient is generated in the dielectric region. That is, the potential of the pattern is also reflected in the dielectric region in contact with the pattern made of the metal or the semiconductor. In general, an amount of secondary electrons emitted from a dielectric is larger than that of a metal or a semiconductor, and sensitivity to a potential is also high. Therefore, in an electrical characteristic inspection of a pattern of a metal or a semiconductor, by analyzing a luminance change in a dielectric region in contact with the pattern of the metal or the semiconductor, sensitivity of the electrical characteristic inspection can be improved.

Hereinafter, embodiments will be described with reference to the accompanying drawings. In the drawings, the same parts are denoted by the same reference signs, and redundant description thereof is appropriately omitted. The accompanying drawings are intended to facilitate the description and understanding of the invention, and it should be noted that shapes, dimensions, ratios, and the like in the drawings may be different from an actual apparatus in some places.

### First Embodiment

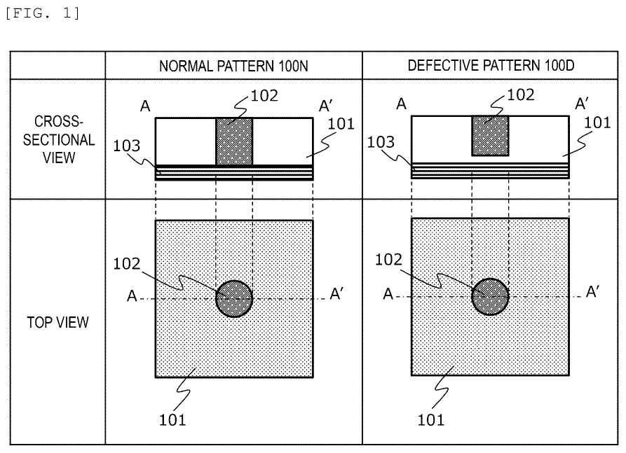

In the following embodiment, an example is shown in which an electron beam is used as a charged particle beam. However, the charged particle beam is not limited to the electron beam as long as the charged particle beam can induce charge on a sample. Emission of the electron beam to the sample causes signal electrons to be emitted from the sample. An SEM images a surface of the sample by scanning the sample with the electron beam and detecting the signal electrons from the sample. An image thus obtained is called an SEM image. FIG. 1 shows an example of a sample pattern to be inspected. A cross-sectional view and a top view are shown for each of a normal pattern 100N and a defective pattern 100D. The cross-sectional view shows a cross-section taken along line AA′ in the top view. A contact plug 102 made of tungsten is made in such a manner that the contact plug 102 is surrounded by an interlayer film 101 formed by SiO₂ deposition. In the normal pattern 100N, the contact plug 102 is connected to lower layer wiring 103 whereas, in the defective pattern 100D, the contact plug 102 is not connected to the lower layer wiring 103, which causes an electrical connection defect.

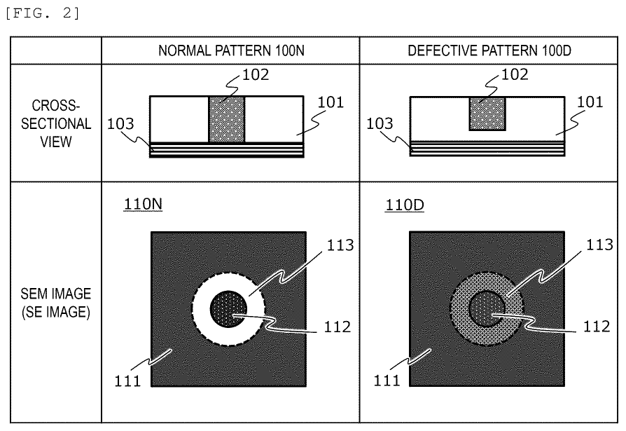

FIG. 2 shows SEM images (secondary electron (SE) images) 110N and 110D acquired for the normal pattern 100N and the defective pattern 100D by cross-sectional views. The normal pattern 100N and the defective pattern 100D are the same as those shown in FIG. 1. Based on a difference in luminance of each SEM image, a first region 111 indicating the interlayer film 101 and a second region indicating the contact plug 102 can be identified. Here, a region having higher luminance than the second region 112 is located at a boundary between the first region 111 and the second region 112, which is referred to as a third region 113. As can be seen from comparison with the cross-sectional view, there is no actual pattern corresponding to the third region 113. In defect inspection according to a voltage contrast method using an SEM image, good-or-defective determination is performed based on the difference in luminance. Therefore, as the difference in luminance due to good-or-defective increases, defect detection sensitivity increases. Since luminance of the second region 112 in the SEM image 110D of the defective pattern is slightly lower than luminance of the second region 112 in the SEM image 110N of the normal pattern, it is difficult to detect such a difference and determine whether the pattern is good or defective.

On the other hand, luminance of the third region 113 in the SEM image 110D of the defective pattern significantly decreases with respect to the luminance of the third region 113 in the SEM image 110N of the normal pattern.

Here, a mechanism by which the third region 113 occurs in the SEM image will be described with reference to FIG. 3. FIG. 3 shows a cross-sectional view, a luminance distribution, and a potential distribution for each of the normal pattern 100N and the defective pattern 100D. As shown in the potential distribution of the normal pattern 100N, the contact plug 102 is electrically connected to the lower layer wiring 103 and is not charged, and thus has a low potential. On the other hand, the interlayer film 101 that is a dielectric is charged by the electron beam, and thus has a high potential. However, since a boundary with which the contact plug 102 is in contact has the same potential as that of the contact plug 102, a potential gradient is generated in the interlayer film 101 as a distance from the contact plug 102 increases. A region where the potential gradient is generated is the third region 113. Magnitude of the potential gradient generated in the interlayer film 101 depends on the potential of the contact plug 102.

As shown in the potential distribution of the defective pattern 100D, since the contact plug 102 is not in contact with the lower layer wiring 103 in the defective pattern 100D, the contact plug 102 is electrically floating. As in the case of the normal pattern 100N, the potential of the interlayer film 101 that is a dielectric increases due to charging. The potential of the contact plug 102 also increases due to charging of the interlayer film 101.

A principle of the defect inspection based on the difference in the SEM luminance distribution reflecting the difference in the potential distribution will be described. An amount of secondary electrons emitted from tungsten, which is generally the material of the contact plug 102, is low. Therefore, an amount of emission hardly changes according to the difference in the potential of the contact plug 102, and thus the change in luminance of the obtained SEM image also decreases. Therefore, a difference between the luminance of the second region 112 in the SEM image 110N of the normal pattern and the luminance of the second region 112 in the SEM image 110D of the defective pattern is small, and detection sensitivity is low. Meanwhile, an amount of secondary electrons emitted from SiO₂, which is the material of the interlayer film 101, is high, and the amount of emission changes greatly according to the potential difference. As described above, the magnitude of the potential gradient of the interlayer film 101 appearing as the third region 113 reflects the difference in the potential of the contact plug 102. Therefore, by analyzing the difference in the luminance of the third region 113, it is possible to inspect an electrical characteristic of the contact plug 102 with high sensitivity.

### <<Explanation of Flowchart>>

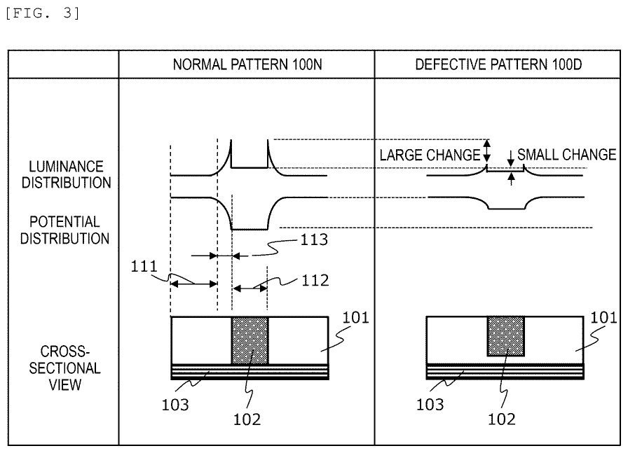

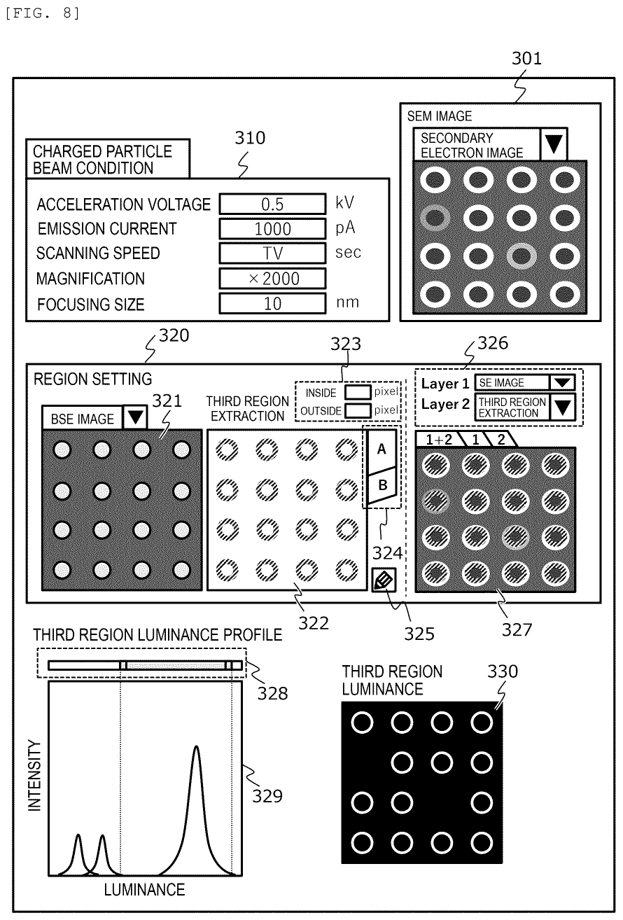

An inspection method according to an embodiment will be described with reference to a flowchart in FIG. 4. An example of an apparatus configuration of a charged particle beam apparatus for carrying out the inspection method is shown in FIG. 7A, and details thereof will be described later.

### (Step 100)

An electron beam is emitted to a sample according to an electron beam condition (charged particle beam condition) set by a user.

### (Step 101)

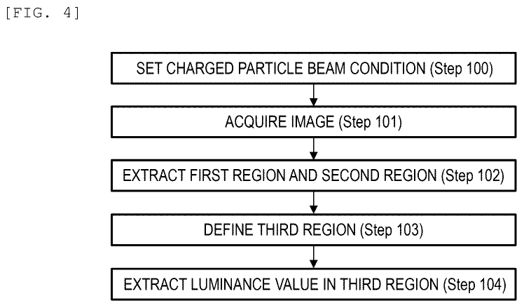

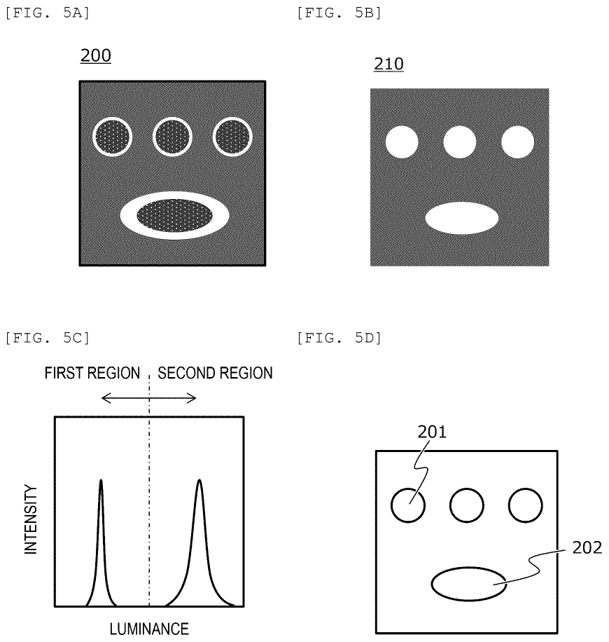

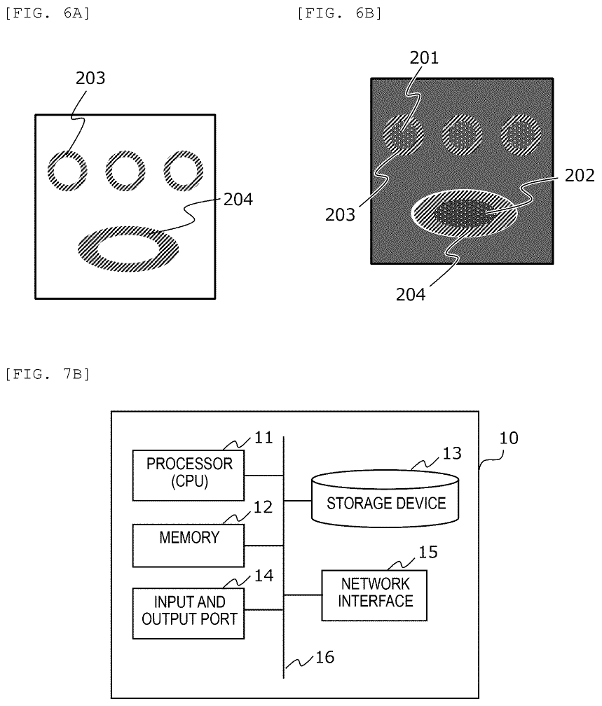

Secondary electrons emitted from a sample 8 due to electron beam emission are detected by an electron detector 5 and imaged. An SEM image imaged based on a detection signal of the secondary electrons is referred to as an SE image. An example of the SE image (schematic view) is shown in FIG. 5A.

### (Step 102)

Structure information corresponding to an SE image 200 (FIG. 5A) is referred to from a region storage unit 38, and a first region and a second region in the SE image 200 are extracted. The first region is a region occupied by a dielectric such as an interlayer film, and the second region is a region occupied by a conductor or a semiconductor such as a contact plug. Here, an example is shown in which a BSE image is used as the structure information used for extraction. The BSE image (backscattered electron image) is an SEM image that is imaged based on a detection signal of BSEs (backscattered electrons, reflected electrons). An example (schematic view) of a BSE image used for region extraction is shown in FIG. 5B. As a BSE image 210, a BSE image acquired simultaneously with the SE image 200 at a BSE detector at the time of execution of Step 101 may be used, or a separately acquired BSE image may be used. Since a BSE emission yield of the semiconductor or the conductor is higher than that of the dielectric, the contact plug is displayed bright in the BSE image as compared to the interlayer film, a difference in materials can be clearly observed, and thus it is easy to determine a boundary between the interlayer film (dielectric region) and the contact plug (conductor or semiconductor pattern). Here, as shown in FIG. 5C, a bright intensity distribution is set as the second region and a dark intensity distribution is set as the first region from a luminance profile of the BSE image 210. Accordingly, as shown in FIG. 5D, the boundary between the first region and the second region (a contour of the contact plug) is extracted. In this example, contact plugs 201 and 202 having different shapes are extracted in the same field of view.

As the structure information, an X-ray image in which a material type difference can be distinguished may be used, or CAD data may be used. A user may specify a region as desired from the acquired SE image.

### (Step 103)

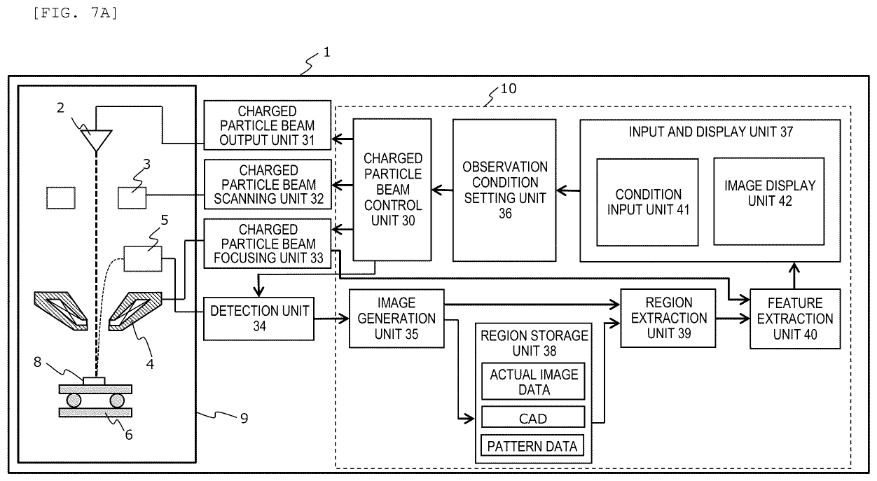

In Step 103, based on the first region and the second region extracted in Step 102, a third region (a region where a potential gradient is generated in the dielectric region (the first region)) is set for the image (SE image) acquired in Step 101. FIG. 6A shows extraction results of third regions 203 and 204 extracted based on the first region and the second region extracted in Step 102. As a method for setting the third region, for example, the third region can be defined as having a width of 10 pixels on an inner side (second region side) and 20 pixels on an outer side (first region side) of the boundary between the first region and the second region shown in FIG. 5D. Since an appearance of the SE image in the third region is affected by a trajectory of secondary electrons in an electron beam apparatus, the third region is defined to include a region somewhat inside the boundary specified based on the structure information. Therefore, as shown in FIG. 6B, it is preferable that the SE image 200 (see FIG. 5A) and the defined third regions 203 and 204 (see FIG. 6A) are displayed in a superimposed manner, and thus the user can check whether the third region defined based on the structure information actually covers a bright region in the SE image appropriately. In this way, the user can reliably extract the appropriate third region by adjusting the definition of the third region on the superimposed image. A method for specifying a size of the third region may be based on pixels or actual dimensions.

In the contact plug 201 and the contact plug 202 having different sizes, the size of the third region can be defined respectively. That is, for the contact plug 201 and the contact plug 202, different pixel sizes inside and outside the boundary can be defined as the third region. When a shape or a material of the contact plug differs, the potential gradient generated in the interlayer film also differs, and thus it is preferable to define the third region for each of contact plugs having different shapes or materials. The second region may be automatically classified according to a difference in a luminance value of the BSE image or luminance of the SE image, a difference in a material based on an X-ray emitted at the time of electron beam emission, CAD data, or a difference in an area or an outer peripheral size of the SEM image, and the third region may be defined for each classification.

### (Step 104)

A luminance value of the third region defined in Step 103 is extracted from the SE image acquired in Step 101.

FIG. 7A shows an apparatus configuration of a charged particle beam apparatus (electron beam apparatus) 1 that is an inspection apparatus. The charged particle beam apparatus 1 includes a charged particle optical system (electron optical system), a stage mechanism system, a beam control system, an image processing system, and an input and output system. The charged particle optical system includes an electron gun 2, a deflector 3, an electron lens 4, and the electron detector 5. The stage mechanism system includes an XYZ stage (sample stage) 6 where the sample 8 to be inspected is placed. The inside of a housing 9 is controlled to a high vacuum, and the charged particle optical system and the stage mechanism system are provided therein. The beam control system includes a charged particle beam control unit 30, a charged particle beam output unit 31, a charged particle beam scanning unit 32, a charged particle beam focusing unit 33, and a detection unit 34. The image processing system includes an image generation unit 35, the region storage unit 38, a region extraction unit 39, and a feature extraction unit 40. The input and output system includes an observation condition setting unit 36 and an input and display unit 37. The input and display unit 37 further includes a condition input unit 41 and an image display unit 42. The observation condition setting unit 36 controls writing of a control value to the charged particle beam control unit 30 based on an electron beam observation condition set by the condition input unit 41. According to the written control value, the electron gun 2, the deflector 3, the electron lens 4, and the electron detector 5 are controlled in a set operation via the charged particle beam output unit 31, the charged particle beam scanning unit 32, the charged particle beam focusing unit 33, and the detection unit 34.

A block (functional unit) surrounded by a dotted rectangle in FIG. 7A indicates a functional unit executed by an information processing device 10. The information processing device 10 includes a processor (CPU) 11, a memory 12, a storage device 13, an input and output port 14, a network interface 15, and a bus 16 as shown in FIG. 7B. The processor 11 functions as a functional unit that provides a predetermined function by executing processing according to a program loaded in the memory 12. The storage device 13 stores data and a program used by the functional unit. As the storage device 13, for example, a non-volatile storage medium such as a hard disk drive (HDD) or a solid state drive (SSD) is used. The input and output port 14 is connected to an input device such as a keyboard or a pointing device, and an output device such as a display (display device) (these are generally referred to as an input and output device), and exchanges signals between the information processing device 10 and the input and output device. The network interface 15 enables communication with another information processing device via a network. These components of the information processing device 10 are communicably connected to each other by the bus 16.

An electron beam accelerated by the electron gun 2 is focused by the electron lens 4 and emitted to the sample 8. The electron lens 4 controls a spot size of a focusing diameter of the electron beam focused on a sample surface. An emission position and an emission range (for example, magnification) on the sample are controlled by the deflector 3. The electron beam is controlled under an electron beam condition such as an acceleration voltage, an emission current, an emission position, a magnification, an emission range, and a focusing size set by the observation condition setting unit 36. Due to the electron beam emission, electrons emitted from the sample 8 are detected by the electron detector 5 to become a detection signal, and are imaged by the image generation unit 35. The region storage unit 38 stores structure information (a size, a material, and the like of the conductor or semiconductor pattern) of the observed sample. Pattern data of the sample may be input from the SEM image and stored, or CAD data may be input from the outside and stored. Further, the SEM image may be captured and specified by the user. The region extraction unit 39 extracts regions of the first region and the second region from the SEM image (SE image) generated by the image generation unit 35 and the structure information in the region storage unit 38, and extracts the third region according to a region size setting value of the third region set by the condition input unit 41. The feature extraction unit 40 extracts the luminance of the third region extracted by the region extraction unit 39 from the SEM image, and outputs the extracted luminance to the input and display unit 37.

FIG. 8 shows an example of a GUI output to the display device. An acceleration voltage, an emission current, a scanning speed, a magnification, a focusing size, and the like, which are basic observation conditions, can be set in a charged particle beam condition setting unit 310. The observed SEM image is displayed on an image display unit 301. Using a pull-down menu, it is possible to select and display the acquired SEM image such as an SE image derived from a secondary electron signal or a BSE image derived from BSEs.

A region setting unit 320 classifies the first region and the second region on the acquired SE image, and sets a condition for extracting the third region. A region selection unit 321 reads the structure information for extracting the first region and the second region. Here, an example is shown in which a BSE image acquired simultaneously when a secondary electron image of the image display unit 301 is acquired is used as the structure information. The first region and the second region are extracted from the BSE image displayed on the region selection unit 321. Extraction of the boundary between the first region and the second region is assumed to be automatically executed from a luminance profile of the BSE image, and the first region and the second region may be manually distinguished from each other through a manual setting unit 325.

Next, the third region generated at the boundary between the first region and the second region is extracted. For this purpose, regions inside and outside the boundary are set by a range region setting unit 323 as a range of the third region. In this example, a pixel size is set from the boundary. When there are plugs (second regions) of different sizes and plugs (second regions) of different materials in the same field of view, a plug type setting unit 324 is provided such that a size of the third region can be defined for each plug. The third region extracted under the condition set in the range region setting unit 323 is displayed on a third region extraction unit 322.

Further, a third region check unit 327 displays the secondary electron image displayed on the image display unit 301 and the extracted third region in a superimposed manner. A layer selection unit 326 can set the secondary electron image and the third region for checking in an alternate or superimposed manner. Accordingly, for example, if the set third region includes a sufficiently dark region in the first region or the second region, the definition of the third region is corrected so as not to include such regions.

Next, the feature extraction unit 40 extracts the luminance value of the third region from the secondary electron image and outputs a luminance profile 329. Here, a luminance region of the third region can be specified by display profile region specification 328, and an image (SE image) of the third region in the specified luminance region is displayed on an extraction region luminance display unit 330.

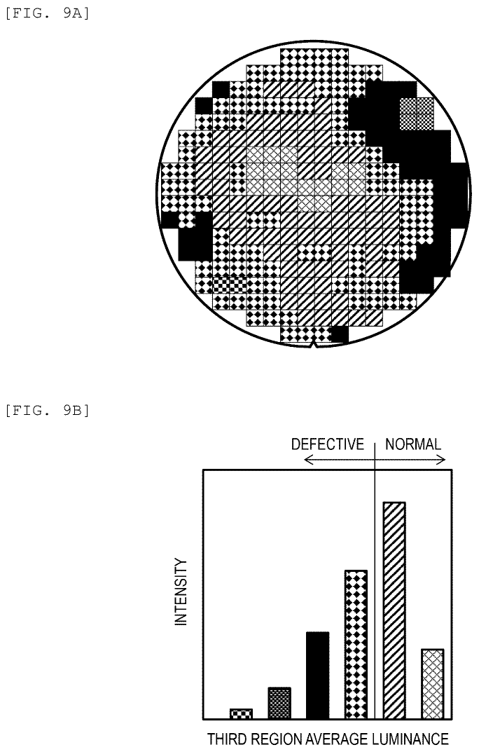

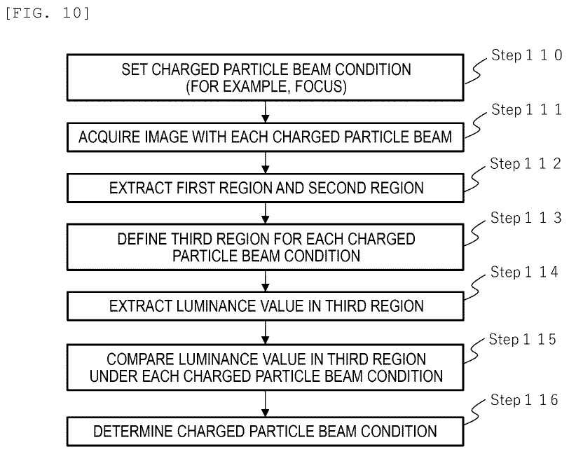

FIG. 9A is an example of a GUI created by the input and display unit 37 in order to present, to the user, a luminance tendency of the third region acquired by executing an inspection flow in the first embodiment within a wafer surface. For example, an average value of luminance of the third region observed for each chip formed within the wafer is obtained, and average luminance of the third region is distinguished into six groups. A wafer surface inner distribution is shown in FIG. 9A, and an intensity distribution is shown in FIG. 9B. A horizontal axis represents an average luminance value, and a vertical axis represents an intensity. Normal-or-defective determination can be made based on the luminance value, and a threshold for determining normal or defective may be set as desired by the user, or the determination may be based on an electrical feature acquired by another device such as a prober or TEM.

By using the first embodiment, an electrical feature of the second region can be inspected with high sensitivity by identifying the first region (the dielectric region such as the interlayer film) and the second region (the conductor or semiconductor pattern such as the contact plug) to extract the third region and acquiring the luminance value of the third region.

### Second Embodiment

In a second embodiment, an inspection method will be described in which luminance values of the third region obtained by emitting an electron beam under a plurality of charged particle beam conditions are compared and a charged particle beam condition (electron beam condition) that increases the luminance value of the third region is determined.

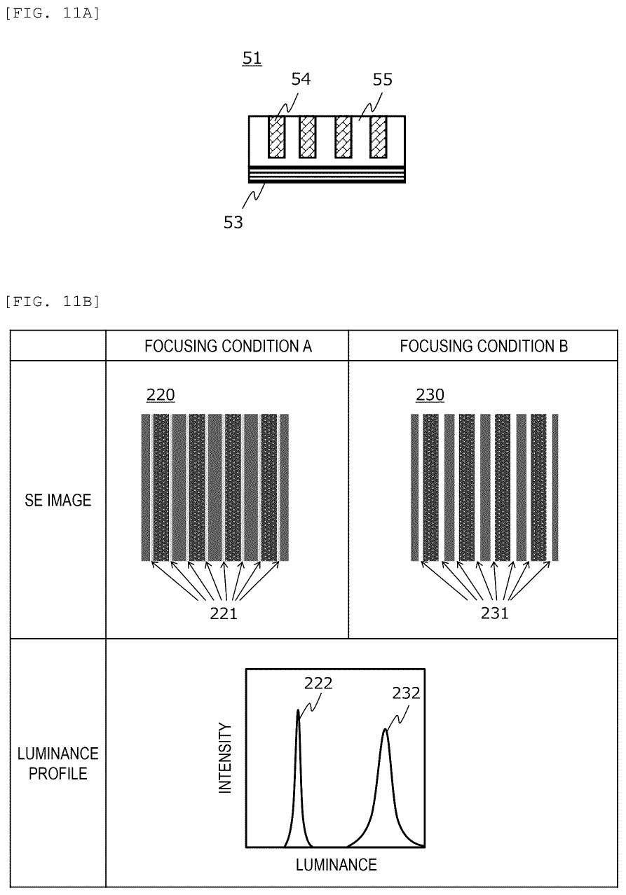

FIG. 10 shows an inspection flow for determining the electron beam condition that increases the luminance value of the third region. In Step 110, a plurality of electron beam conditions are set. For example, electron beam conditions with different focus conditions are set. The plurality of electron beam conditions can be set by the charged particle beam condition setting unit 310 on the GUI shown in FIG. 8. Next, in Step 111, an SEM image (SE image) is acquired for each electron beam condition set in Step 110. In Step 112, as in Step 102 in the flowchart in FIG. 4, the first region and the second region are extracted from the SE image under each electron beam condition using the structure information. In Step 113, the third region is defined for each SE image acquired under each electron beam condition. The method for defining the third region for each SE image is the same as that in Step 103 in the flowchart in FIG. 4. When there are second regions having different areas and materials in the same field of view, the third region is defined for each classification of the second region. In Step 114, the luminance value of the third region extracted in Step 113 is extracted. In Step 115, luminance values of the third region under each electron beam condition are compared. In Step 116, among the electron beam conditions compared in Step 115, one having a higher luminance value of the third region is determined as an optimum electron beam condition (charged particle beam condition).

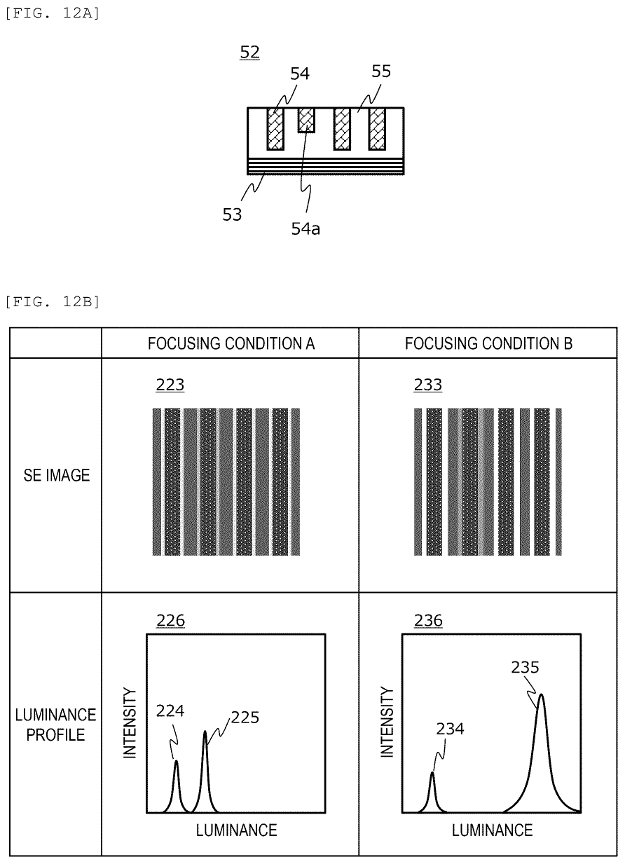

An example of determining the optimum electron beam condition according to the flow in FIG. 10 will be described. FIG. 11A is a cross-sectional view of a sample 51 to be observed. A TEOS film 55 that is a dielectric is formed on a Si substrate 53, and Poly-Si lines 54 are embedded in the TEOS film 55. Two types of electron beam conditions having different focusing conditions are used. FIG. 11B shows observation results under focusing conditions A and B for the sample 51. The focusing condition A is a focusing condition (just-focus condition) under which a contour of a sample surface is sharpest, and a secondary electron image 220 (schematic view) is acquired. The focusing condition B is a focusing condition (defocus condition) under which a focusing diameter is larger than that under the focusing condition A, and a secondary electron image 230 (schematic view) is acquired. When the focusing condition of the electron beam is changed, an area of the third region generated in the second region changes according to the electron beam condition, and thus a width of the third region is set for each electron beam condition. A third region 221 is extracted from the SE image 220, and a third region 231 is extracted from the SE image 230. When comparing luminance profiles of the third regions under the focusing condition A (SE image 220) and the focusing condition B (SE image 230), a profile 232 under the electron beam condition having a larger focusing diameter has a higher luminance value than a profile 222 under the electron beam condition having a smaller focusing diameter. That is, since the focusing condition B reflects a potential gradient with high sensitivity, the focusing condition B can be determined as the optimum condition.

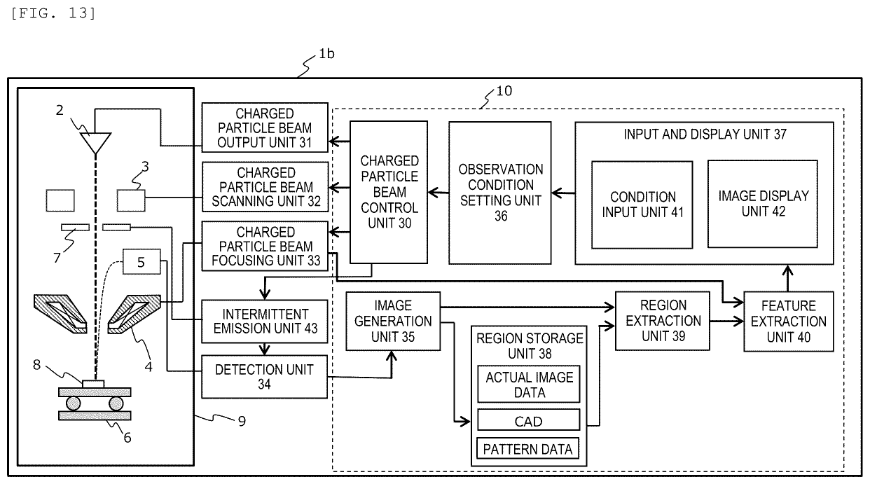

A modified example of the electron beam condition determination method will be described. FIG. 12A is a cross-sectional view of a sample 52 to be observed. Although a basic structure is the same as that of the sample 51 shown in FIG. 11A, only one Poly-Si line 54a among the four line-shaped Poly-Si lines 54 is shallow. Accordingly, since a film thickness of the TEOS film 55 between the Poly-Si lines 54 and the Si substrate 53 increases, capacitance and resistance increase, and a discharge amount decreases. Therefore, the other three Poly-Si lines 54 are more likely to be charged. Therefore, a potential gradient is smaller than that of the other three Poly-Si lines, and thus the luminance value of the third region is small.

FIG. 12B shows observation results under the focusing conditions A and B for the sample 52. The focusing conditions A and B are the same as the electron beam conditions at the time of acquiring the secondary electron image shown in FIG. 11B. Luminance profiles 226 and 236 in the third region are obtained from an SE image 223 under the focusing condition A and an SE image 233 under the focusing condition B, respectively. Profiles 224 and 234 are intensity distributions representing the Poly-Si line 54a, and profiles 225 and 235 are intensity distributions representing the other three Poly-Si lines. As shown in FIG. 12B, luminance variation in the third region is larger under the focusing condition B than under the focusing condition A. That is, a potential state of the Poly-Si line (second region) can be detected with higher sensitivity under the focusing condition B than under the focusing condition A. In this way, the electron beam condition may be determined such that luminance value variation is large in the same field of view or within a wafer.

By using the second embodiment, it is possible to extract the luminance of the third region obtained under a plurality of electron beam conditions and determine the electron beam condition such that a luminance difference between good and defective increases.

### Third Embodiment

In a third embodiment, an example is shown in which a pulsed charged particle beam apparatus that can emit a pulsed electron beam to a sample is used as the charged particle beam apparatus. The pulsed electron beam is emitted to the sample, and signal electrons emitted from the sample are detected by an electron detector in synchronization with the pulsed electron beam to form an image. Charging of the sample decays at different rates depending on a time constant based on a capacitance component and a resistance component of a pattern. The pulsed charged particle beam apparatus can quantitatively grasp a transient charging phenomenon. That is, based on a difference in the luminance value of the third region under electron beam conditions having different intermittent (interval) times, an electrical characteristic such as a resistance value or a capacitance value can be quantitatively measured with high sensitivity in addition to defect-or-normal determination. In quantitative measurement of the electrical characteristic, it is necessary to acquire a plurality of SE images by changing the intermittent condition and use a luminance change in the acquired SE images. Therefore, in the cases of the first and second embodiments, it is sufficient to define the third region for each SE image, whereas, when the quantitative analysis is performed in the third embodiment, a region for measuring the luminance change is necessarily common to the plurality of SE images acquired by changing the intermittent condition. In order to distinguish third regions of each SE image, a region commonly set for the plurality of SE images is referred to as a third region segmentation. In order to improve inspection sensitivity, the third region segmentation is set such that a luminance difference in the SE image is maximized.

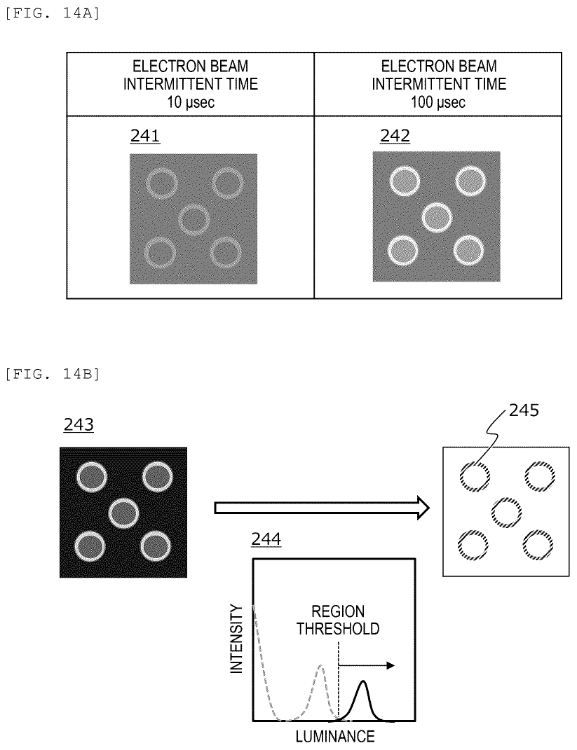

FIG. 13 shows an apparatus configuration of a pulsed charged particle beam apparatus (pulsed electron beam apparatus) 1b that is an inspection apparatus. The configuration is the same as that of the inspection apparatus shown in FIG. 7A, and a beam shutter 7 is added to the charged particle optical system and an intermittent emission unit 43 is added to the beam control system as mechanisms for intermittently emitting an electron beam. The observation condition setting unit 36 controls writing of a control value to the charged particle beam control unit 30 based on an electron beam intermittent condition set by the condition input unit 41. The intermittent emission unit 43 controls the beam shutter 7 such that the electron beam is emitted to the sample 8 at a set intermittent emission time or a set timing according to the control value. The detection unit 34 detects secondary electrons by the electron detector 5 in synchronization with the pulsed electron beam controlled by the intermittent emission unit 43.

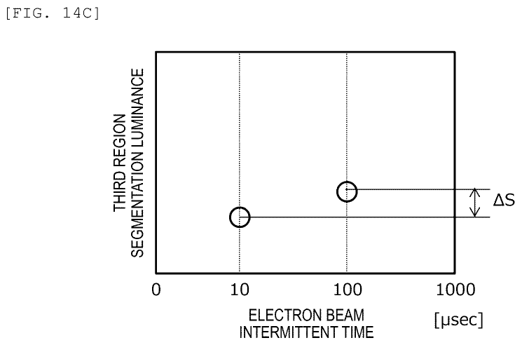

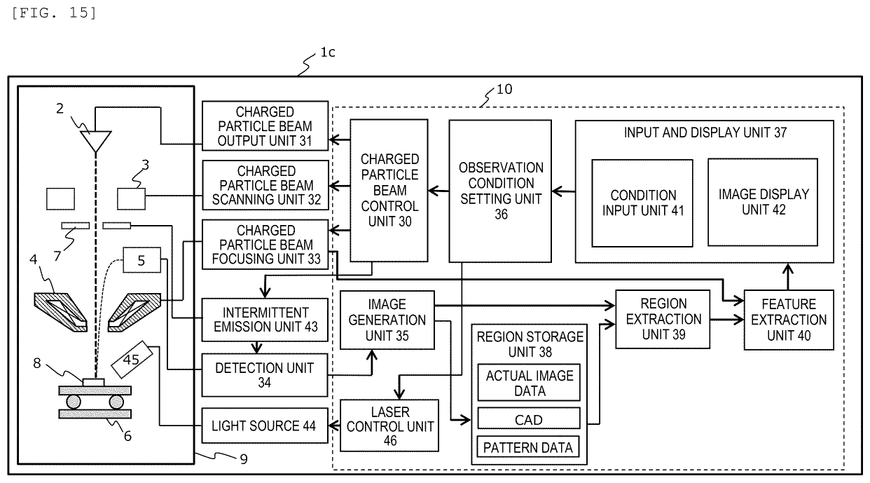

In the third embodiment, a luminance difference in the SE image is calculated under a series of intermittent conditions of the electron beam, and a region where the luminance difference is large is set as the third region segmentation. FIG. 14A shows secondary electron images (schematic views) acquired for each emission interval (intermittent condition) of the electron beam. Here, the electron beam intermittent condition is 10 μsec and 100 μsec, an SE image when the intermittent condition is 10 μsec is an SE image 241, and an SE image when the intermittent condition is 100 μsec is an SE image 242.

Next, a method for extracting the third region segmentation from the two SE images will be described with reference to FIG. 14B. First, a difference image of secondary electron images under two intermittent conditions is created. The difference image is an image in which a luminance difference between the two images is a luminance value, and the difference image becomes brighter (has higher luminance) as the luminance difference increases. Here, since the luminance difference due to a difference between the intermittent conditions in the third region in the SE image is large as compared to a luminance difference due to a difference between intermittent conditions in the first region and the second region in the SE image, a pattern similar to the SE image appears also in a difference image 243 in which the luminance difference is a luminance value. A third region segmentation 245 is extracted from a luminance profile 244 in the difference image 243 based on a high luminance side profile. For example, as shown in FIG. 14B, an extraction luminance threshold (region threshold) may be set, and a luminance region higher than the threshold may be set as the third region segmentation. The threshold can be set as desired by the user.

Next, for the extracted third region segmentation 245, a luminance value of the SE image 241 (whose intermittent condition is 10 μsec) and a luminance value of the SE image 242 (whose intermittent condition is 100 μsec) are acquired. FIG. 14C shows an output example thereof.

When there is a third region having a different luminance change with respect to the intermittent condition in the same field of view, the third region segmentation may be extracted such that the luminance change increases with respect to each intermittent condition. That is, a plurality of types of third region segmentations may be extracted within the same field of view. An example of extracting a plurality of third region segmentations is shown in a fourth embodiment to be described later.

According to the third embodiment, it is possible to extract the third region segmentation in a manner that increases the luminance change through the plurality of intermittent conditions, and to perform quantitative inspection with high sensitivity.

### Fourth Embodiment

In the fourth embodiment, an example is shown in which, as a charged particle beam apparatus, a charged particle beam apparatus is used to perform observation by controlling a charging state by emitting, for example, ultraviolet light to a sample. In this case, in addition to the electron beam condition, it is necessary to extract a third region segmentation common to a plurality of SE images to increase the luminance change in the third region for each light emission condition.

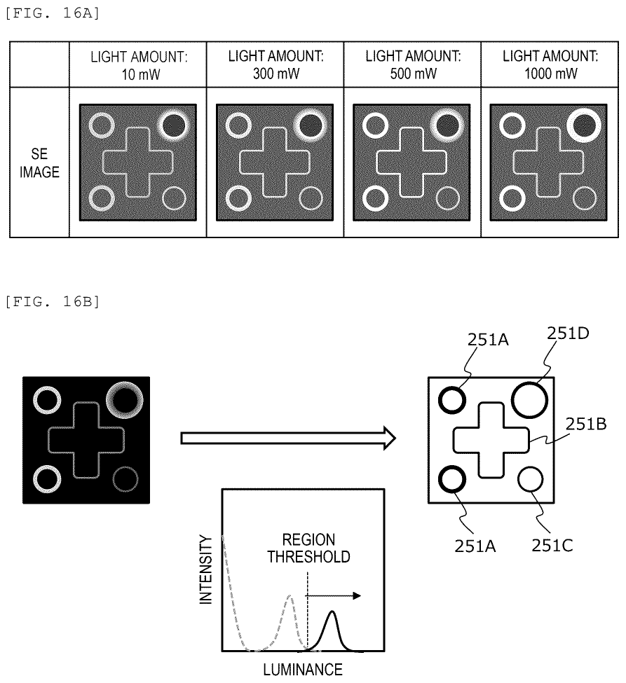

FIG. 15 shows an apparatus configuration of a pulsed charged particle beam apparatus (pulsed electron beam apparatus) 1c that is an inspection apparatus. In addition to the apparatus configuration and functions of the inspection apparatus in FIG. 13, a light source 44 for laser emission, an emission optical system 45, and a laser control unit 46 are added. As the light source 44, a monochromatic light source is used. The laser may be wavelength-tunable laser whose wavelength can be selected by parametric oscillation. In addition, a wavelength conversion unit that generates an optical harmonic may be used. A light emission region is preferably wider than an electron beam deflection region controlled by the deflector 3 in order to obtain an image with a uniform image contrast. The light may be a continuous wave light source or a pulsed light source, or a continuous light source may be pulsed by an electro-optical modulator or an acousto-optical modulator. The light and the electron beam may be emitted simultaneously or at different timings. Secondary electrons emitted when the electron beam is emitted to the sample 8 to which the light is emitted are detected by the electron detector 5. A detection signal detected by the electron detector 5 forms an SEM image by the image generation unit 35 and is displayed on the image display unit 42. The charged particle beam apparatus may also be implemented by adding the light source 44 for laser emission, the emission optical system 45, and the laser control unit 46 to the apparatus configuration and the functions of the inspection apparatus in FIG. 7A. In this case, a continuous charged particle beam is emitted to the sample.

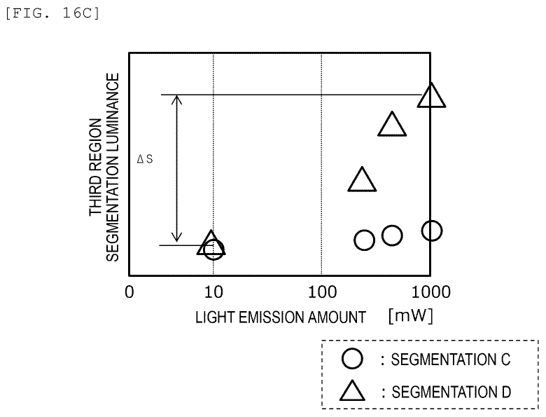

By emitting light under different emission conditions to the sample 8, the luminance of the third region in the SE image of the sample 8 changes. A procedure for determining the third region segmentation in which a luminance change with respect to the light emission condition increases will be described below. FIG. 16A shows an example of secondary electron images acquired under an electron beam observation condition and a light emission condition set as desired by the user. Here, an example is shown in which the secondary electron images are acquired under the same electron beam observation condition whereas the light emission conditions are 10 mW, 300 mW, 500 mW, and 1000 mW.

As in the third embodiment, a difference image of the secondary electron images under the four light emission conditions is created. For example, when the difference image is created in an all-pairs manner for the four SE images, six difference images are created. A method for extracting the third region segmentation in which a luminance value of the difference image increases can be implemented in the same manner as in the third embodiment as shown in FIG. 16B. That is, an extraction luminance threshold (region threshold) is set, and a luminance region having a luminance profile of luminance higher than the threshold is set as the third region segmentation.

When there is a third region having a different luminance change with respect to the light emission condition in the same field of view, the third region segmentation may be extracted such that the luminance change increases with respect to each intermittent condition. In FIG. 16B, four types of third region segmentations are extracted. Differences in types are indicated by subscripts A to D of the reference signs. The third region segmentation may be extracted based on different difference images for each type of the third region segmentation.

Luminance values in third region segmentations extracted from the secondary electron images shown in FIG. 16A are acquired for extracted third region segmentations 251A to 251D. FIG. 16C shows an output example thereof.

According to the fourth embodiment, in addition to electron beam observation, it is possible to extract the third region segmentation in which the luminance change is large based on the luminance change in the third region when light is emitted under each light emission condition, and it is possible to perform quantitative inspection with high sensitivity.

The invention is not limited to the embodiments described above, and includes various modifications. For example, the above-described embodiments have been described in detail to facilitate understanding of the invention, and the invention is not necessarily limited to those including all the configurations described. A part of a configuration of a certain embodiment can be replaced with a configuration of another embodiment, and a configuration of another embodiment can be added to a configuration of a certain embodiment. A part of a configuration according to each embodiment may be added to, deleted from, or replaced with another configuration.

### Reference Signs List

1, 1b, 1c: charged particle beam apparatus
2: electron gun
3: deflector
4: electron lens
5: electron detector
6: XYZ stage
7: beam shutter
8: sample
10: information processing device
11: processor (CPU)
12: memory
13: storage device
14: input and output port
15: network interface
16: bus
31: charged particle beam output unit
32: charged particle beam scanning unit
33: charged particle beam focusing unit
34: detection unit
35: image generation unit
36: observation condition setting unit
37: input and display unit
38: region storage unit
39: region extraction unit
40: feature extraction unit
41: condition input unit
42: image display unit
43: intermittent emission unit
44: light source
45: emission optical system
46: laser control unit
51, 52: sample
53: Si substrate
54: Poly-Si line
55: TEOS film
100N: normal pattern
100D: defective pattern
101: interlayer film
102: contact plug
103: lower layer wiring
110: SEM image
111: first region
112: second region
113: third region
200: SE Image
201, 202: contact plug
203, 204: third region
210: BSE image
220, 230, 223, 233: secondary electron image
221, 231: third region
222, 232: profile
224, 225, 234, 235: profile
226, 236: luminance profile
241, 242: SE image
243: difference image
244: luminance profile
245, 251: third region segmentation
301: image display unit
310: charged particle beam condition setting unit
320: region setting unit
321: region selection unit
322: third region extraction unit
323: range region setting unit
324: plug type setting unit
325: manual setting unit
326: layer selection unit
327: third region check unit
328: display profile region specification
329: luminance profile
330: extraction region luminance display unit

1. An inspection method for inspecting an electrical characteristic of a pattern made of a conductor or a semiconductor in a dielectric region on a sample, the inspection method comprising:
scanning the sample with a charged particle beam to acquire a secondary electron image;
calculating a feature based on a luminance value of a third region extending from a boundary between a first region and a second region toward the first region and having a higher luminance than the second region, the first region corresponding to the dielectric region and the second region corresponding to the pattern in the secondary electron image; and
inspecting the electrical characteristic of the pattern based on the feature.

2. The inspection method according to claim 1, wherein
the third region is generated by a potential gradient in the dielectric region of the sample.

3. The inspection method according to claim 1, wherein
the boundary is extracted based on structure information of the sample.

4. The inspection method according to claim 3, wherein
a backscattered electron image or an X-ray image acquired by scanning the sample with the charged particle beam, or CAD data of the sample is used as the structure information of the sample.

5. The inspection method according to claim 1, wherein
the sample is scanned with a charged particle beam under a first charged particle beam condition to acquire a first secondary electron image,
the sample is scanned with a charged particle beam under a second charged particle beam condition to acquire a second secondary electron image, and
a charged particle beam condition of the charged particle beam in acquiring the secondary electron image is determined based on a comparison between a luminance profile of the third region in the first secondary electron image and a luminance profile of the third region in the second secondary electron image.

6. The inspection method according to claim 5, wherein
a focusing diameter of the charged particle beam under the first charged particle beam condition on the sample is different from a focusing diameter of the charged particle beam under the second charged particle beam condition on the sample.

7. The inspection method according to claim 1, wherein
a charged particle beam condition of the charged particle beam in acquiring the secondary electron image is a defocus condition.

8. An inspection method for inspecting an electrical characteristic of a pattern made of a conductor or a semiconductor in a dielectric region on a sample, the inspection method comprising:
scanning the sample with a pulsed charged particle beam under a first intermittent condition to acquire a first secondary electron image;
scanning the sample with a pulsed charged particle beam under a second intermittent condition to acquire a second secondary electron image;
extracting a first third region segmentation based on a high luminance side luminance profile in a difference image between the first secondary electron image and the second secondary electron image; and
inspecting the electrical characteristic of the pattern based on a feature based on a luminance value of the third region segmentation in the first secondary electron image and the second secondary electron image.

9. An inspection method for inspecting an electrical characteristic of a pattern made of a conductor or a semiconductor in a dielectric region on a sample, the inspection method comprising:
scanning the sample, to which light under a first light emission condition is emitted, with a charged particle beam to acquire a first secondary electron image;
scanning the sample, to which light under a second light emission condition is emitted, with a charged particle beam to acquire a second secondary electron image;
extracting a third region segmentation based on a high luminance side luminance profile in a difference image between the first secondary electron image and the second secondary electron image; and
inspecting the electrical characteristic of the pattern based on a feature based on a luminance value of the third region segmentation in the first secondary electron image and the second secondary electron image.

10. The inspection method according to claim 8, wherein
the third region segmentation is included in a high luminance region generated by a potential gradient in the dielectric region of the sample in the first secondary electron image and the second secondary electron image.

11. A charged particle beam apparatus comprising:
a sample stage on which a sample where a pattern made of a conductor or a semiconductor is formed in a dielectric region is placed;
a charged particle optical system configured to emit a charged particle beam to the sample; and
an information processing device configured to inspect an electrical characteristic of the pattern based on a secondary electron image acquired by scanning the sample with the charged particle beam, wherein
the information processing device calculates a feature based on a luminance value of a third region extending from a boundary between a first region and a second region toward the first region and having a higher luminance than the second region, the first region corresponding to the dielectric region and the second region corresponding to the pattern in the secondary electron image, and inspects the electrical characteristic of the pattern based on the feature.

12. The charged particle beam apparatus according to claim 11, wherein
the third region is generated by a potential gradient in the dielectric region of the sample.

13. The charged particle beam apparatus according to claim 11, wherein
the secondary electron image is a secondary electron image acquired by scanning the sample with the charged particle beam under a defocus condition by the charged particle optical system.

14. The charged particle beam apparatus according to claim 11, wherein
the charged particle optical system emits a pulsed charged particle beam to the sample, and
the information processing device extracts a first third region segmentation based on a high luminance side luminance profile in a difference image between a first secondary electron image acquired by scanning the sample with a pulsed charged particle beam under a first intermittent condition and a second secondary electron image acquired by scanning the sample with a pulsed charged particle beam under a second intermittent condition, and inspects the electrical characteristic of the pattern based on a feature based on a luminance value of the third region segmentation in the first secondary electron image and the second secondary electron image.

15. The charged particle beam apparatus according to claim 11, wherein
the charged particle optical system emits light to the sample, and
the information processing device extracts a third region segmentation based on a high luminance side luminance profile in a difference image between a first secondary electron image acquired by scanning the sample, to which light under a first light emission condition is emitted, with a charged particle beam, and a second secondary electron image acquired by scanning the sample, to which light under a second light emission condition is emitted, with a charged particle beam, and inspects the electrical characteristic of the pattern based on a feature based on a luminance value of the third region segmentation in the first secondary electron image and the second secondary electron image.

16. The inspection method according to claim 9, wherein
the third region segmentation is included in a high luminance region generated by a potential gradient in the dielectric region of the sample in the first secondary electron image and the second secondary electron image.
